(19) United States
(12) Patent Application Publication
(10) Pub. No.: US 2004/0084794 A1
(43) Pub. Date: May 6, 2004

(54) Method for producing a molding in a mould

(76) Inventor: Jurgen Frey, Kirchheim/Teck (DE)

Correspondence Address: BACHMAN & LAPOINTE, P.C., 900 CHAPEL STREET, SUITE 1201, NEW HAVEN, CT, 06510, US

(21) Appl. No.: 10/473,520

(22) PCT Filed: Mar. 23, 2002
(86) PCT No.: PCT/EP02/03296

(30) Foreign Application Priority Data
Apr. 5, 2001 (DE) 101170017

(51) Int. Cl. B29C 45/76

(52) U.S. Cl. 264/40.5; 264/40.6

(57) ABSTRACT

A method for producing a moulded part in a mould comprising at least one cavity that is surrounded by a mould wall. The temperature of the mould wall and the internal pressure of the mould are measured and analyzed and the analysis is used to regulate the injection speed, the dwell pressure, the dwell pressure time and/or the mould temperature.

The invention relates to a method for producing a molding in a mold having at least one cavity which is surrounded by a mold wall.

In the past (e.g. EP 0 087 069 A1), it has been assumed that setting an injection-molding or pressure machine to be as constant as possible will also produce constant moldings. However, the process conditions are permanently changing on account of the numerous and complex influences, such as for example fluctuations in the material batch, fluctuations in viscosity, influences of temperature, etc. Accordingly, if the machine setting is left constant, the properties of the moldings will also change, meaning that the moldings produced will differ from one another.

To compensate for the permanent influences on the injection-molding process, it is inevitably necessary to constantly adapt the setting of the machine parameters. Nowadays, according to EP 0 897 786 A2, this is achieved by measuring and analyzing the internal pressure of the mold. The result of the analysis represents the correction to the setting parameters. The changes in the injection rate, the holding pressure and the holding pressure time are measured. The individual process phases are analyzed over time on the basis of the mold internal pressure profile, requiring a high level of process know-how.

It is an object of the present invention to provide a method of the abovementioned type which allows the number of parameters which are to be changed to be kept as small as possible and simplifies the analysis of the parameters.

This object is achieved by virtue of the fact that the temperature of the mold wall is measured and analyzed, and the injection rate, the holding pressure, the holding pressure time and/or the mold temperature are controlled on the basis of this analysis.

It is preferable for the mold wall temperature to be measured together with a measurement of the mold internal pressure. The physical properties which have been measured can then be used to draw conclusions as to the particular setting parameters required.

In particular, the shrinkage of the moldings produced can be kept constant. In the case of small moldings with just one temperature-control circuit, the temperature is preferably measured at the end of the cavity, i.e. at the end of the filling phase. In the case of large moldings, it is preferable for the temperature to be determined in the zone of each temperature-control circuit.

Furthermore, the mold wall temperature is also used to control the cooling time as a function of temperature, to determine when to switch from filling pressure to holding pressure and to balance the volumetric filling in the case of multi-impression molds.

To make the control method simpler and in particular less process-dependent, the measured parameters should be plotted not against time but rather against a reference value for the same parameter. Complete correspondence between the current value and the reference value will result in a 45° straight line. This also makes the method easier for untrained operators to work.

The advantage of the method according to the invention is that optimized moldings are constantly reproduced in a simple way.

1. A method for producing a molding in a mold having at least one cavity which is surrounded by a mold wall, characterized in that the temperature of the mold wall is measured and analyzed, and the injection rate, the holding pressure, the holding pressure time and/or the mold temperature is/are controlled on the basis of the analysis.

2. The method as claimed in claim 1, characterized in that the internal pressure in the cavity is also determined and is used to control the process parameters.

3. The method as claimed in claim 2, characterized in that the internal pressure is determined close to the gate.

4. The method as claimed in one of claims 1-3, characterized in that the temperature which is determined and/or the internal pressure is plotted against a reference value for the same parameter and presented.
